(19) United States
(12) Patent Application Publication
(10) Pub. No.: US 2009/0150380 A1
(43) Pub. Date: Jun. 11, 2009

(54) SYSTEM AND METHOD FOR PROCESSING SOCIAL RELATION ORIENTED SERVICE

(75) Inventors: Yun Yen Chen, Kaohsiung City (TW); Yu Shiang Sheng, Taipei City (TW); Wen Wei Lin, Tainan County (TW); Jenn Lien Chu, Kaohsiung City (TW)

Correspondence Address: WPAT, PC;INTELLECTUAL PROPERTY ATTORNEYS, 2030 MAIN STREET, SUITE 1300, IRVINE, CA, 92614, US

(73) Assignee: INDUSTRIAL TECHNOLOGY RESEARCH INSTITUTE, Hsinchu (TW)

(21) Appl. No.: 12/183,322

(22) Filed: Jul. 31, 2008

(30) Foreign Application Priority Data
Dec. 6, 2007 (TW) 096146455

(51) Int. Cl. G06F 17/30

(52) U.S. Cl. 707/5; 707/E17.014

(57) ABSTRACT

A method for social relationship oriented service processing, which comprises steps of: providing relationship data, searching for at least one first level social member from a first level social network according to the relationship data, forwarding a list of the first level social members to a server, and searching by the server for at least one second level social member from a second level social network according to the list and the relationship data.

### BACKGROUND OF THE INVENTION

1. Field of the Invention

The present invention relates to a social relationship oriented service processing system and method.

2. Description of the Related Art

The current personal apparatuses, such as cell phones, PDAs, iPods and so forth, have only one work mode for the user to use. Under this mode, a user must make sure what he is going to do, and then he can give the apparatus a command. The limitation will cause the user to be in no mood to share something emotionally. With the development of Web 2.0, the focus of social interactions changes to the user, and this change also influences those personal apparatuses having only one work mode. To date, most systems of the apparatuses still follow the original one mode design rule, and this situation limits the flexibility, expandability, and economic efficiency of the systems. Aiming at the potentiality, the present invention proposes a new operation mode of a system and method.

U.S. Pat. No. 7,069,308, related to the present invention, discloses a method and apparatus for calculating, displaying and acting upon relationships in a social network. A computer system collects descriptive data about various individuals and allows those individuals to indicate other individuals with whom they have a personal relationship. The descriptive data and the relationship data are integrated and processed to reveal the series of social relationships connecting any two individuals within a social network. The pathways connecting any two individuals can be displayed. Further, the social network itself can be displayed to any number of degrees of separation. A user of the system can determine the optimal relationship path to reach desired individuals. A communications tool allows individuals in the system to be introduced and initiate direct communication.

U.S. Pat. No. 7,188,153 is a continuation of the U.S. Pat. No. 7,069,308 and discloses a system for managing connections in an online social network. The online social network collects descriptive data about various individuals and allows those individuals to indicate other individuals with whom they have a personal relationship. A maximum degree of separation setting is provided and the maximum degree of separation setting limits the amount of searching.

U.S. Pat. No. 6,681,108 discloses a unique identification associated with a private identification for each entity accessing the network. A known list is maintained for each entity. Each entry in the known list for a particular entity includes the unique identification and private identification of other entities known to the particular entity.

But the above-mentioned patents don't provide a solution to the limitations in social network flexibility, expandability, and economic efficiency.

### SUMMARY OF THE INVENTION

The present invention proposes a method for social relationship oriented service processing, which comprises steps of: providing relationship data, searching for one or more first level social members from a first level social network according to the relationship data, forwarding a list of the first level social members to a server, and searching by the server for one or more second level social members from a second level social network according to the list and the relationship data.

The present invention proposes a system for social relationship oriented service, which comprises a device and a server. The device includes a first level social network, which is the collection of the interpersonal relationships of the user. The server communicating with the device includes a second level social network, which is the expansion of the interpersonal relationships of the members of the first level social network.

### BRIEF DESCRIPTION OF THE DRAWINGS

The invention will be described according to the appended drawings in which:

FIG. 1 is a flow diagram of the process of the social relationship oriented service according to one embodiment of the present invention;

FIG. 2 shows the service-processing modes of the social relationship oriented service according to one embodiment of the present;

FIG. 3 is a flow diagram of the process of the social relationship oriented service according to one embodiment of the present invention;

FIG. 4 shows a hint diagram of the semantic analysis of the social relationship oriented service according to one embodiment of the present invention;

FIG. 5 is a flow diagram of searching for social members according to one embodiment of the present invention; and

FIG. 6 shows a flow diagram of searching for social members in a server according to one embodiment of the present invention.

### PREFERRED EMBODIMENT OF THE PRESENT INVENTION

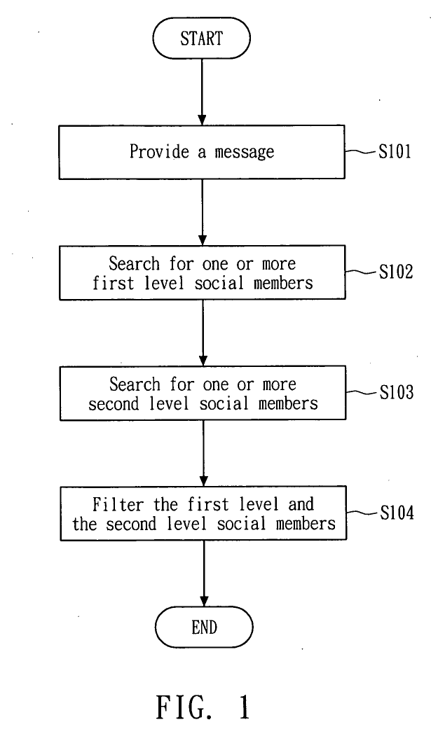

FIG. 1 is a flow diagram of the process of the social relationship oriented service according to one embodiment of the present invention. A user of a device wishes to share a message with others, so the user submits a request for providing the message (Step S101). The system related to the present invention processes the request through 3 stages. The first stage is called the focusing stage. In this stage, the social network program of the device searches by relationship data the database containing first level social network information for one or more first level social members, who are highly likely to be interested in the message (Step S102). The first level social network is the collection of the interpersonal relationships of the user. In the second stage, called the diffusing stage, the social network program of a server searches the second level social members, who are highly likely to be interested in the messages, by the relationship data from the second level social network, which extends the interpersonal relationships of the members of the first level social network (Step S103). The second level social network information may be stored in, for example, a database of the server. In the last stage, called the filtering stage, the program of the server filters out the members who don't meet the personal preference data stored in the server, among both levels of social members (Step S104). The whole process is automatic. The user, who wants to share a message by this system, doesn't have to send the message one by one, as was previously necessary. The system comprises all necessary hardware including processors used to execute the instructions related to the present invention and memory devices coupled to the processors and used to store the above mentioned instructions for execution, etc. The processor may be implemented as any type of processor including commercially available microprocessors from companies such as Intel, AMD, IBM, Motorola, ARM, VIA, TI, Freescale, and the like. The memory device, which is used to store the program or data, may include volatile and non-volatile memory devices, for example, DRAM, Flash, EPROM or ROM.

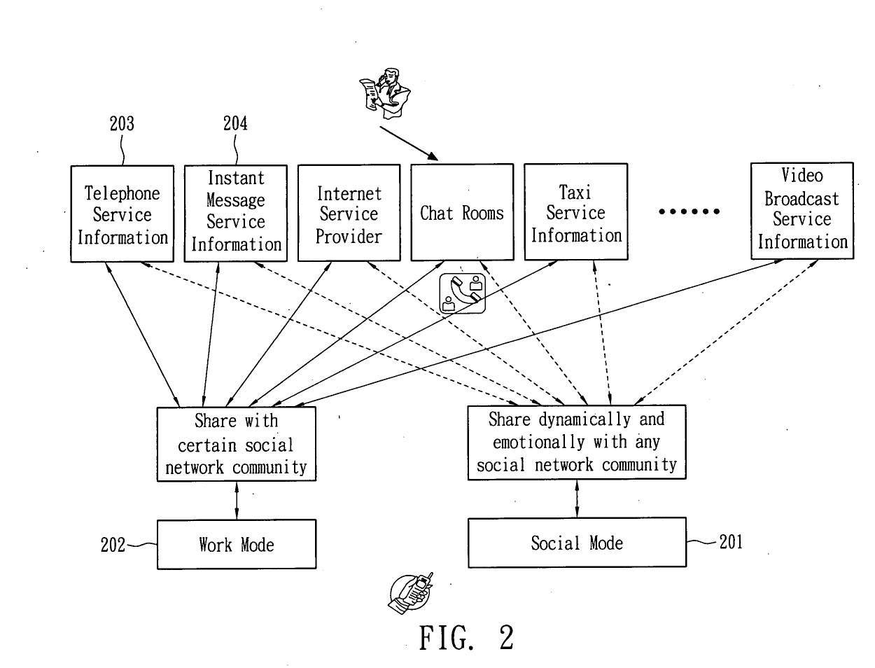

FIG. 2 shows the service-processing modes of the social relationship oriented service according to one embodiment of the present invention. The present invention provides two modes, which can be selected through a user interface, for sharing messages: the social mode 201 and the work mode 202. The user interface can include a graphical user interface. The user can share his message by searching any social network community in the Internet for social members, or join any sharing activity dynamically and emotionally in social mode. The user can also share his message with only a certain social network community in work mode. The user can choose one of these two modes to share or accept the message. The message includes, for example, the telephone service information 203, the instant message service information 204 and other materials or resources in the network.

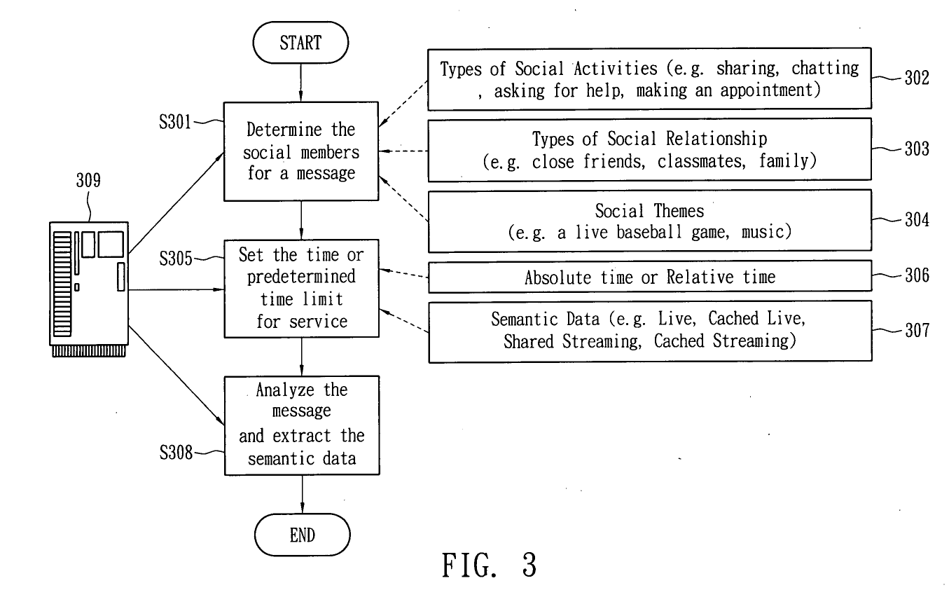

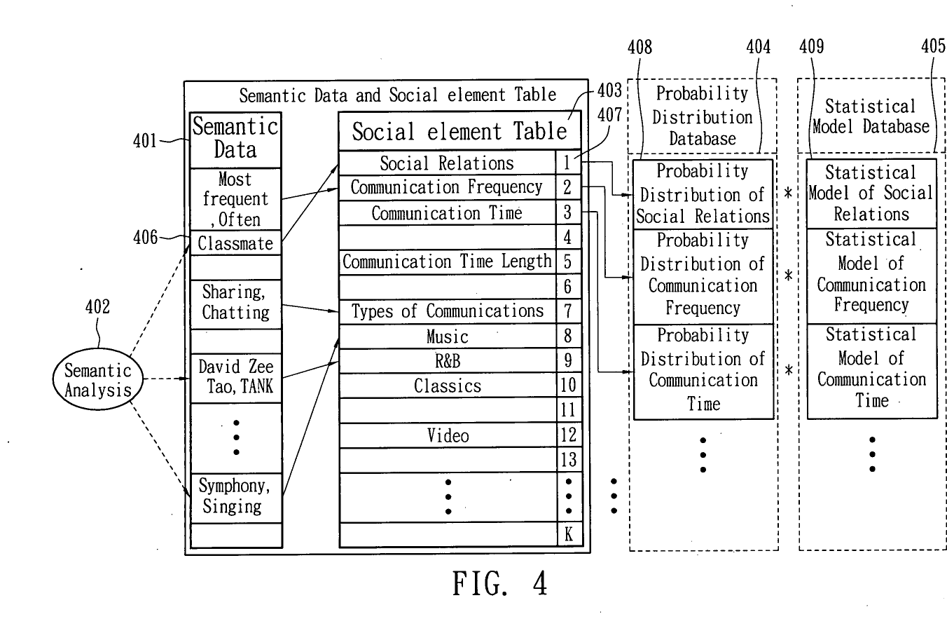

FIG. 3 is a flow diagram of the process of the social relationship oriented service according to one embodiment of the present invention. When a user wants to share a message with others, he provides the system with the data having the content information of the service and the types of people for whom the message is provided. Social network programs stored in the server and device automatically analyze the data, and share the message with the targeted social members. At Step S301, a user determines the targeted social members for the message. In the step, the user provides the system with the message and also the data including the types of social interactions 302, the types of social relationships 303, and the social themes 304. The social activities 302 include sharing, chatting, asking for help, making an appointment, and so on. The social relationships 303 are the relationships of the social members with the user, who receive the message, including close friends, classmates, family, and so on. The social theme 304 is the content of the message such as a baseball game or music. At Step S305, the user can set the time or predetermined time limit for the service of the message. The sharing of the message related to the present invention is automatic. The message is sent to all social members having social relationships with the user and being interested in the social theme 304 of the message in the network. So, there is a time difference between the time that the social members receive the message and the time that the message starts sharing. It may be necessary to set the time or predetermined time limit for the message to halt the sharing activity, for example, if the service of the message is finished, the sharing activity should be stopped. The time limit can be set by absolute time and relative time 306, or by a semantic method. The semantic content 307 of the semantic method may include, for example, Live, Cached Live, Shared Streaming, and Cached Streaming. If a semantic method is used, after semantic extraction, the time limit is calculated and set automatically. At Step S308, when the time limit is set, the program immediately analyzes the message and extracts the semantic data. The program in the device may be downloaded from the server, and will be updated synchronously and regularly. FIG. 4 shows a hint diagram of the semantic analysis of the social relationship oriented service according to one embodiment of the present invention. The semantic data 401 is extracted by semantic analysis 402. The social elements, used to evaluate the relationship data among social members and corresponding to the semantic data, are selected from the social element table 403. The probability distributions and the statistical models of the social elements, which are used to calculate the values of the social elements, are retrieved from the probability distribution database 404 and the statistical model database 405 separately. For example, in the embodiment, Classmate 406 is one element of the semantic data 401, and its corresponding social element is “social relations” 407. The value of the social element can be calculated by multiplying the probability distribution 408 of the social relations 407 and the statistical model 409 of the social relations 407. The probability distribution is the communication frequency defined over the same range of time intervals, and the time interval may be, for example, one day, one to two days, or two to three days. At every time interval, the value of probability distribution is normalized over the total number of communication links.

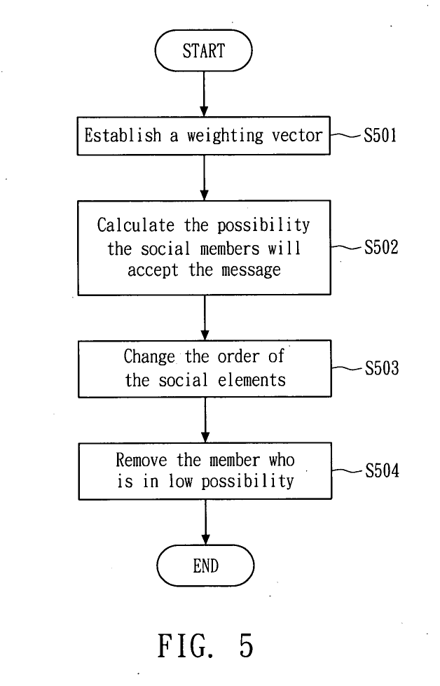

FIG. 5 is a flow diagram of searching for social members according to one embodiment of the present invention. At Step S501, a weighting vector for weighing social elements is established first, and the device's social members who are qualified for message sharing are searched out by the vector calculation. The weighting vector has a number of vector elements (weighting values), and the number of these elements is the same as the number of the social elements of the social element database, and they represent the strength of the social relationship among the social members.

The social elements corresponding to the message are analyzed by the above-mentioned semantic analysis. After the social elements are extracted, the element values of the vector corresponding to the social elements are set. Those elements having no corresponding social elements in the semantic analysis are set to zero. The established weighting vector is for estimation of the social relationships of the social members, who may be interested in the shared message. The value of the vector element may be determined by user input, and is used for weighing the corresponding social element. For example, in a semantic analysis of the message, the semantic data includes at least the first social element and the fourth social element, and the weighting vector looks like: V_{device}=[C₁,0,0,C₄,0, . . . }.

At Step S502, the probability of acceptance by a social member is calculated by using a relation vector and the weighting vector, established at Step S501. If the probability of acceptance of a social member is higher than a threshold, the social member is added to a possible list. For example, if the relationship between a user and one of his social members, j, is represented by a relation vector, Value(e_{self,j}), the probability of acceptance is the inner product between V_{device} and Value(e_{self,j}), i.e. V_{device}·Value(e_{self,j}). The calculation based on statistical records is used to estimate the probability that a social member will accept the message. A social member having probability higher than a threshold is listed in L_{possible}. Value(e_{self,j}) is a relation vector containing all social elements. The value of the social element is a statistical data based on a probability-model-based analysis of the communication behaviors among social members.

At Step S503, the system calculates the product of the relation vector and the weighting vector, V_{device}×Value(e_{self,j}), of every member in the list, L_{possible}. This cross product is calculated by multiplying one element of the relation vector and its corresponding element of the weighting vector individually. After the calculation is finished, the system binds the calculated vectors into a matrix, and changes the order of the calculated social element of the matrix within a rule by row or column switching. After that, the calculated social elements will be arranged from high priority to low priority.

At Step S504, the social member whose highest-priority social element has low value is removed from the list.

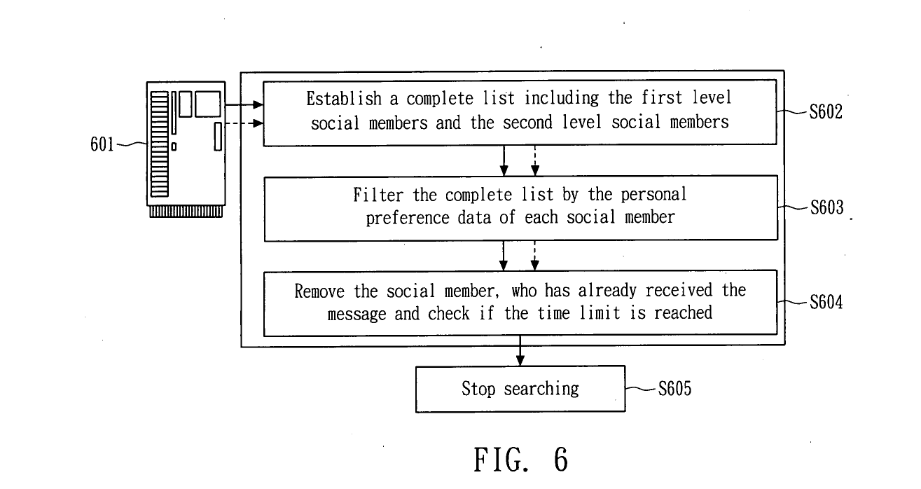

FIG. 6 shows a flow diagram of searching for social members in a server according to one embodiment of the present invention. After the search for first level social members in a device, the list of the first level social members and the message are forwarded to a server 601. The server extracts the semantic data by semantic analysis of the message, gathers the corresponding social elements, and sets the element values of a weighting vector. At Step S602, in the diffusing stage, the server searches its second level social network and establishes a complete list including the first level social members and the second level social members who have interpersonal relationships with the first level social members, and also calculates the probability of acceptance of each second level social member. Through the process, the number of social members is expanded. At Step S603, the server, which performs filtering procedures including instructions for filtering, filters the complete list according to the personal preference data of each social member. The personal preference data may include messages about blocking contacts, disliked music or the shutdown status of social contact mode. After the filtering process, the server generates a new list. At Step S604, the server checks a shared list and removes social members who have already received the message, and checks whether the time limit has been reached. If the time limit has not been reached, the server sends the message to all remaining social members and adds these social members to a shared list. At Step S605, the server checks whether all of the possible social members are in the shared list. If they are all in the list, the server stops searching.

The above-described embodiments of the present invention are intended to be illustrative only. Numerous alternative embodiments may be devised by person skilled in the art without departing from the scope of the following claims.

What is claimed is:

1. A method for processing social relationship oriented service, comprising the steps of:
providing relationship data for a device;
searching for at least one first level social member from a first level social network according to the relationship data;
forwarding a list of the at least one first level social member to a server; and
searching by the server for at least one second level social member from a second level social network according to the list and the relationship data.

2. The method of claim 1, further comprising:
providing a message;
extracting semantic data of the message; and
selecting at least one corresponding first social element from a device database by the semantic data, wherein the relationship data is evaluated by the first social elements.

3. The method of claim 2, further comprising:
determining weighting values corresponding to the first social elements; and
searching the first level social network for the first level social members, whose weighted sum of the first social elements exceeds a first threshold, wherein the first social elements are weighted with their corresponding weighting values.

4. The method of claim 3, further comprising:
retrieving probability distributions and statistical models corresponding to the first social elements; and
determining the values of the first social elements by performing multiplication of the corresponding probability distributions and the corresponding statistical models respectively.

5. The method of claim 3, further comprising:
changing the order of the first social elements within a rule; and
removing the first level social member whose first social element priority is lower than a second threshold.

6. The method of claim 2, further comprising:
receiving the message by the server;
extracting the semantic data of the message by the server; and
selecting at least one corresponding second social element from a server database by the semantic data.

7. The method of claim 6, further comprising:
determining weighting values corresponding to the second social elements; and
searching the second level social network for the second level social members whose weighted sum of the social elements exceeds a first threshold, wherein the second social elements are weighted with their corresponding weighting values.

8. The method of claim 7, further comprising:
retrieving probability distributions and statistical models corresponding to the second social elements; and
determining the values of the second social elements by performing multiplication of the corresponding probability distributions and the corresponding statistical models respectively.

9. The method of claim 7, further comprising:
changing the order of the second social elements within a rule; and
removing the second level social member whose second social element priority is lower than a second threshold.

10. The method of claim 1, further comprising:
setting a time limit for service; and
stopping the search of the second level social members if the time limit is reached.

11. The method of claim 1, further comprising:
retrieving a personal preference data on the server; and
filtering the first and second level social members by the personal preference data in the device and the server, respectively.

12. A system for processing social relationship oriented service, comprising:
a device having a first level social network, wherein the first level social network is a collection of interpersonal relationships of users; and
a server communicated with the device having a second level social network, wherein the second level social network expands interpersonal relationships of members of the first level social network.

13. The system of claim 12, wherein the device comprises:
a processor;
a memory coupled to the processor and comprising a device program mechanism, including instructions for searching at least one first level social member from a first level social network according to relationship data; and
a user interface coupled to the processor.

14. The system of claim 13, further comprising a first member searching mechanism, including instructions for searching the first level social network for the first level social members whose weighted sum of first social elements exceeds a first threshold, wherein the first social elements selected by semantic data extracted from a message and used to evaluate the relationship data are weighted with their corresponding weighting values, and the value of the first social element is determined by performing multiplication of a probability distribution and statistical model corresponding to the first social element.

15. The system of claim 14, further comprising a member-removing mechanism, including instructions for removing the first level social member whose highest-priority first social element value is lower than a second threshold.

16. The system of claim 13, wherein the user interface comprises:
a social mode for searching any social network community on the Internet for social members, or joining any sharing activity dynamically; and
a work mode for sharing messages with a certain social network community.

17. The system of claim 13, wherein the server comprises:
a processor;
a memory coupled to the processor and comprising a server program mechanism, including instructions for searching at least one second level social member from a second level social network according to a list of the first level social members and relationship data.

18. The system of claim 17, further comprising a second member searching mechanism, including instructions for searching the second level social network for the second level social members whose weighted sum of second social elements exceeds a first threshold, wherein the second social elements selected by semantic data extracted from a message and used to evaluate the relationship data are weighted with their corresponding weighting values, and the value of the second social element is determined by performing multiplication of a probability distribution and statistical model corresponding to the second social element.

19. The system of claim 18, further comprising a member-removing mechanism, including instructions for removing the second level social member whose highest-priority second social element value is lower than a second threshold.

20. The system of claim 19, further comprising a filtering mechanism, including instructions for filtering the first and second level social members by a personal preference data.
